(19) United States
(12) Patent Application Publication
(10) Pub. No.: US 2009/0214388 A1
(43) Pub. Date: Aug. 27, 2009

(54) METHOD FOR MANUFACTURING THE SCALE, SCALE, AND ENCODER-EQUIPPED APPARATUS

(75) Inventors: Koichi Saito, Matsumoto-shi (JP); Shinichi Tonami, Jakata-shi (JP); Kenji Matsuyama, Shiojiri-shi (JP); Nagamitsu Takashima, Okaya-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/371,441

(22) Filed: Feb. 13, 2009

(30) Foreign Application Priority Data
Feb. 15, 2008 (JP) 2008-034031
Feb. 12, 2009 (JP) 2009-029226

(51) Int. Cl. G01N 21/00; B32B 38/04

(52) U.S. Cl. 422/82.05; 156/256

(57) ABSTRACT

[Object] To provide a method for manufacturing a scale having an improved abrasion resistance, the scale, and an encoder having the same.

[Solving Means] A scale base material 17 is arranged on the upper surface of a mount 26. A pattern base material 18′ as a material of pattern portions 18 are laminated on the upper surface of the scale base material 17. In this laminated state, the pattern base material 18′ is punched toward the scale base material 17 via a press work. Accordingly, the punched pattern base material 18′ is embedded and held in a thickness of the scale base material 17, and the pattern portions 18 are formed.

### TECHNICAL FIELD

The present invention relates to a method for manufacturing a scale, the scale, and an encoder-equipped apparatus and, more specifically, to a method for manufacturing the scale having an improved abrasion resistance, the scale, and the encoder-equipped apparatus having the same.

### BACKGROUND ART

A linear encoder is adapted to measure the position of an object to be measured and a moved distance of the same by reading a plurality of pattern portions formed on a front surface of an elongated band-shaped scale base material at a regular pitch by a detection head (sensor). For example, a linear encoder used in an ink jet printing apparatus (printer) as a kind of liquid ejecting apparatus is configured to detect moved positions or velocities of ink jet printheads (a kind of liquid ejecting heads, hereinafter, referred to as printheads) mounted on a carriage in the primary scanning direction (see Patent Document 1). In a case of configuration in which a printing medium such as a printing paper is transported by an endless belt (transporting belt) or the like (for example, see Patent Document 2), the amount of transport of the printing medium is detected by a linear encoder attached to the endless belt. In addition, detection signals of the linear encoder define the timing of generation of drive signals for driving a drive source (pressure generating means) for discharging liquid at the printheads.

### CITED REFERENCES OF RELATED ART

[Patent Document]

[Patent Document 1] JP-A-2006-192892

[Patent Document 2] JP-A-2006-187872

### DISCLOSURE OF THE INVENTION

### Problems to be Solved by the Invention

In general, a linear scale in the related art forms pattern portions by printing or deposition on a front surface of a scale base material. In the linear encoder in the related art as described above, there is a risk of abrasion or separation of the pattern portions by the contact of a sensor, a cable for sending control signals, or the like with a pattern portion printed front surface of the linear scale. Accordingly, it makes the sensor incapable of detecting the pattern portions, and consequently, there arises a risk of impairment of a normal detecting operation.

In view of such circumstances, it is an object of the present invention to provide a method for manufacturing a scale which is able to enhance its abrasion resistance, the scale, and an encoder-equipped apparatus having the same.

### Means for Solving the Problem

In order to achieve the object as described above, the present invention is characterized in that pattern portions are formed by punching a pattern base material toward a scale base material via a press work in a state in which the pattern base material is laminated on the scale base material, and embedding at least part of the punched pattern base material in a thickness of the scale base material to be held therein.

The present invention is suitable for a configuration in which a plurality of the pattern portions are arranged in a row at a regular pitch to form a detection pattern.

The punching described above may be achieved by performing at least two different types of punching in a predetermined sequence according to the position of the scale base material.

In this configuration described above, since the pattern portions are formed by punching the pattern base material toward the scale base material via the press work in the state in which the pattern base material is laminated on the scale base material, embedding the punched pattern base material in the thickness of the scale base material to be held therein, the abrasion resistance of the pattern portions may be improved than those in the related art. In other words, for example, abrasion or separation of the pattern portions in the case where the detection pattern comes into contact with other parts or the like may be restrained. Consequently, lowering of the detection accuracy of an encoder is prevented. Also, improvement of durability is further ensured.

In the configuration described above, the pattern portions are preferably embedded entirely in the thickness of the scale base material.

In this configuration, by embedding the pattern portions entirely in the thickness of the scale base material, further improvement of abrasion resistance is achieved.

The detection pattern may be a plurality of pattern portions formed of a plurality of types of metals having different compositions repeated in a predetermined order, or a plurality of types of pattern portions having different colors may be repeated in a predetermined order. In addition, it may includes the pattern portions having a plurality of different depths from the front surface of the scale base material to the front surfaces of the pattern portions and having different depths such that the plurality of depths are repeated in a predetermined order.

In this manner, by configuring the detection pattern by arranging the plurality of types of pattern portions having different compositions, colors, or depths in the predetermined order and repeating this arrangement, a sensor adequate to the type of the pattern portions may be used, so that the sensors adequate to the environments may be used while incorporating the features of the sensors. Also, for example, by arranging three types or more of the pattern portions in a predetermined order, the direction of relative movement of the scale becomes detectable.

### BRIEF DESCRIPTION OF THE DRAWINGS

FIG. 1 is a schematic plan view for explaining a configuration of a printer.

FIG. 2 is a schematic side view for explaining the configuration of the printer.

FIG. 3 is an enlarged view of an area A in FIG. 1.

FIG. 4 is a cross-sectional view taken along the line B-B in FIG. 1.

FIG. 5 is a cross-sectional view of a principal portion for explaining a configuration of a press mechanism.

FIGS. 6(a) to (c) are sketches for explaining a process of forming a pattern portion.

FIG. 7 is a plan view, partly broken, of another embodiment of a linear scale formed with a detection pattern with pattern portions in different depths.

FIG. 8 is a plan view, partly broken, of another embodiment of the linear scale formed with a detection pattern with pattern portions in different metal materials.

FIG. 9 is a plan view, partly broken, of another embodiment of the linear scale formed with a detection pattern with pattern portions in different colors.

FIG. 10 is a plan view, partly broken, of another embodiment of the linear scale formed with a detection pattern with pattern portions formed of magnetic material and non-magnetic materials and arranged alternatively.

### DESCRIPTION OF EXEMPLARY EMBODIMENTS

Referring now to the attached drawings, a best mode for carrying out the present invention will be described. In embodiments described below, various limitations are given as preferred embodiments of the present invention. However, the scope of the present invention is not limited thereto unless otherwise specifically stated as limiting the present invention in the description below. Also, in the description given below, a configuration in which a scale (linear scale) in the present invention and an encoder-equipped apparatus (linear encoder) having the same are applied to an ink jet printing apparatus (hereinafter, simply referred to as a printer) is exemplified.

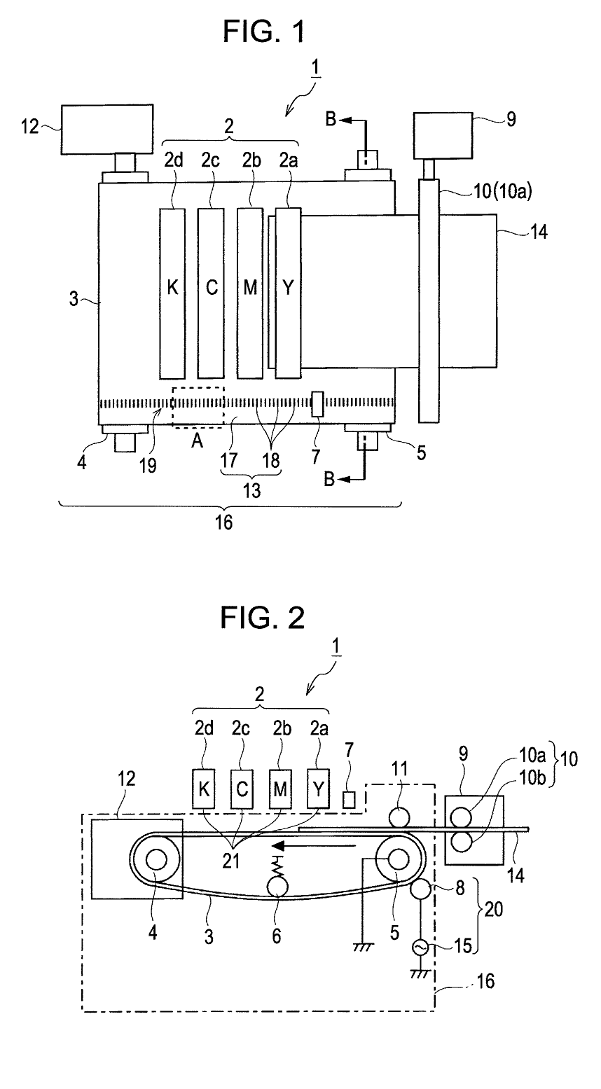

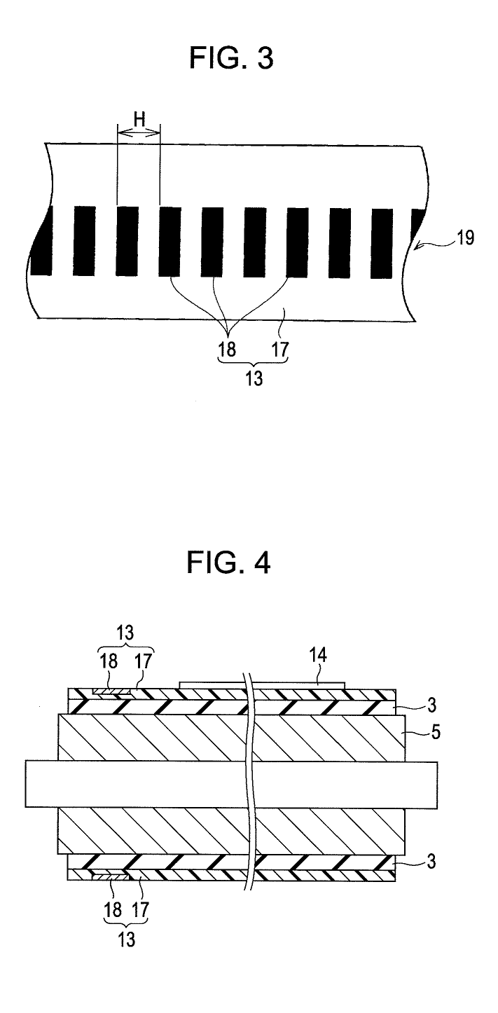

FIG. 1 is a schematic plan view for explaining a configuration of a printer 1, and FIG. 2 is a schematic side view for explaining the configuration of the printer 1. FIG. 3 is an enlarged view of an area A in FIG. 1, and FIG. 4 is a cross-sectional view taken along the line B-B in FIG. 1. The printer 1 roughly includes a plurality of printheads 2 (2a to 2d) arranged in the direction of transport of a printing paper 14 (a kind of printing media), a paper feeding roller 10 configured to supply the printing paper 14 to a transporting belt 3, a paper feeding motor 9 configured to drive the paper feeding roller 10, a transporting mechanism 16 configured to transport the printing paper 14 by the transporting belt 3, and a linear encoder including a linear scale 13 and a detection head 7 (corresponding to a sensor in the present invention). The printer 1 in this embodiment is a so-called line-head type ink jet printing apparatus in which only transports the printing paper 14 for printing but does not move the printheads 2.

The paper feeding roller 10 is disposed on the upstream side of the transporting mechanism 16, and includes a pair of upper and lower rollers 10a, 10b (see FIG. 2) which are able to rotate synchronously in the direction opposite from each other in a state of pinching the printing paper 14 fed from a paper feeding unit, not shown. The paper feeding rollers 10 are configured to be driven by a power from the paper feeding motor 9, and feed the printing paper 14 toward the transporting mechanism 16 after having corrected a skewing of the printing paper 14 with respect to the transporting direction thereof and a positional displacement in the direction orthogonal to the transporting direction in cooperation with a skew correcting roller, not shown.

The transporting mechanism 16 includes a transporting motor 12 as a drive source of the transporting belt 3, a drive roller 4 to which a power is transmitted to the transporting motor 12, a driven roller 5 disposed on the upstream side from the drive roller 4, the endless transporting belt 3 provided between the drive roller 4 and the driven roller 5 with a tension, a tension roller 6 (see FIG. 2) configured to provide a tension to the transporting belt 3, a press contact roller 11 (see FIG. 2) configured to press the printing paper 14 toward the transporting belt 3, and a belt charging portion 20 (see FIG. 2) for charging the transporting belt 3. The tension roller 6 is disposed between the drive roller 4 and the driven roller 5, is inscribed with the transporting belt 3, and provides a tension to the transporting belt 3 by an urging force of an urging member such as a spring. The press contact roller 11 is disposed right above the driven roller 5 with the intermediary of the transporting belt 3, and is in abutment with the transporting belt 3.

The belt charging portion 20 includes a charging roller 8 and a charging power source 15. The charging roller 8 is disposed below the driven roller 5 with the intermediary of the transporting belt 3 on the upstream side, and is in abutment with the transporting belt 3. The charging power source 15 is connected with the charging roller 8 for conduction, and applies an AC voltage to the charging roller 8. The driven roller 5 is grounded as shown in FIG. 2, and serves as an opposed electrode with respect to the charging roller 8 which opposes thereto with the intermediary of the transporting belt 3. The belt charging portion 20 is configured to supply electric charge to the transporting belt 3 by the charging power source 15 via the charging roller 8 to charge the transporting belt 3. On the printing paper 14 placed on the charged transporting belt 3, dielectric polarization occurs, so that electrostatic adsorptive power is generated between the printing paper 14 and the transporting belt 3. In addition, the press contact roller 11 presses the printing paper 14 placed on the charged transporting belt 3 against the transporting belt 3 to enhance the adhesion of the printing paper 14 with respect to the transporting belt 3.

As shown in FIG. 1 and FIG. 4, the linear scale 13 is disposed on the outer peripheral front surface of the transporting belt 3 over the entire circumference of the belt. The linear scale 13 includes a detection pattern 19 arranged on a scale base material 17 formed of synthetic resin such as PET (polyethylene terephthalate) in the longitudinal direction of the scale base material 17. As shown in FIG. 3, the detection pattern 19 includes a plurality of pattern portions 18 formed of a material which reflects detection light from the detection head 7, described later, and arranged in a row at a regular pitch in the printing paper transporting direction. In this embodiment, the respective pattern portions 18 are formed of a thin metal sheet material of stainless steel or the like for example (a pattern base material 18′, described later), and are arranged at a pitch of 180 LPI (Lines Per Inch) in the printing paper transporting direction. The thickness of the pattern portions 18 is thinner than the scale base material 17 and, for example, one-third to a half the thickness of the scale base material 17.

As shown in FIG. 4, the width of the scale base material 17 is aligned with the width of the transporting belt 3, and is provided so as to cover the entire front surface of the transporting belt 3. The detection pattern 19 is formed on one end portion of the scale base material 17 in terms of the width (lower side in FIG. 1, left side in FIG. 4) at a position lying outside the printing paper 14 of a maximum size. Then, the respective pattern portions 18 which constitute the detection pattern 19 are embedded in a thickness of the scale base material 17. This point will be described later.

The detection head 7 includes a reflecting type optical sensor having a light-emitting element and a light-receiving element, and is arranged at a position opposing the detection pattern 19 on the scale base material 17 of the transporting belt 3 with a clearance kept from the scale base material 17. The detection head 7 detects the pattern portions 18 by detection light outputted from the light-emitting element toward the transporting belt 3 and reflected by the pattern portions 18, and then inputted to the light-receiving element. In other words, when the detection light is inputted to the light-receiving element, an output signal from the detection head 7 (hereinafter, referred to as an encoder signal) is switched from a Lo-level to a Hi-level in pulses and assumes an ON state. Then, when the detection light is deviated from the pattern portions 18 and is reflected from the scale base material 17 irregularly, or is absorbed by the scale base material 17, the encoder signal is switched from the Hi-level to the Low-level in pulses and assumes an OFF state. Then, the encoder signal is outputted to a control unit, not shown, of the printer 1. Therefore, the control unit is able to grasp the amount of transport of the printing paper 14 by the transporting mechanism 16 (transporting belt 3) on the basis of the encoder signal. The encoder signal defines the timing of generation of drive signals for driving pressure generating means of the printheads 2.

The printheads 2 includes a yellow printhead 2a configured to discharge (eject) ink in yellow (Y), a magenta print head 2b configured to discharge ink in magenta (M), a cyan printhead 2c configured to discharge ink in cyan (C), and a black printhead 2d configured to discharge ink in black (K), as shown in FIG. 1. A plurality of nozzles (not shown) are formed on nozzle front surfaces 21 (see FIG. 2) of the printheads 2a, 2b, 2c, 2d in respective colors arranged across a length larger than the width of the printing paper 14. The printheads 2a, 2b, 2c, 2d are disposed with the nozzle front surfaces 21 opposing the printing paper 14 and with a certain clearance kept between the nozzle front surfaces 21 and the printing paper 14. As the system of discharging ink of the printheads 2, systems such as electrostatic actuator system, piezoelectric system, or film boiling system may be employed.

Subsequently, a method of manufacturing the linear scale 13 will be described.

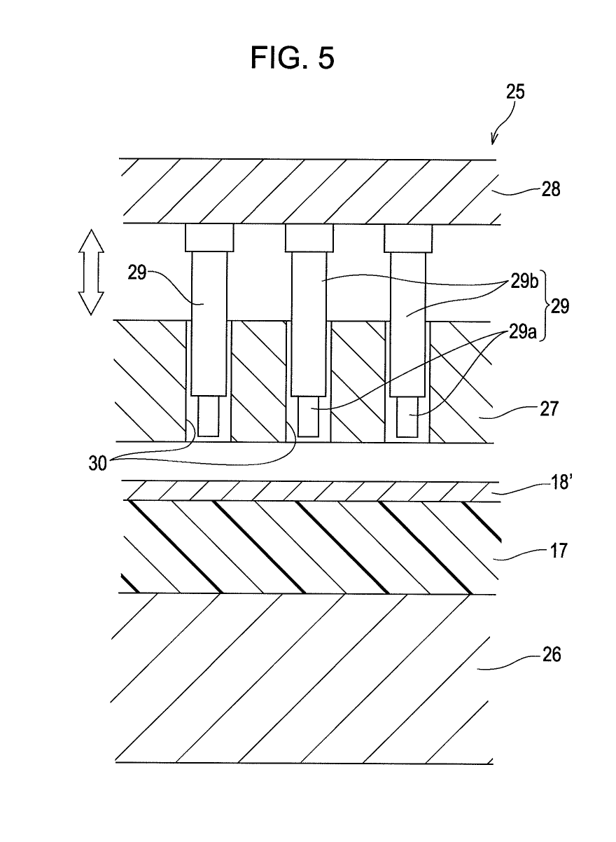

FIG. 5 is a cross-sectional view of a principal portion for explaining a configuration of a pressing machine 25 for forming the detection pattern 19 on the scale base material 17. The exemplified pressing machine 25 includes a mount (press platen) 26, a stripper plate 27, a punch holder 28, and punches 29 or the like. A plurality of the punches 29 are provided at a distance of an integral multiple (for example, two times) of the distance of formation of the pattern portions 18. The stripper plate 27 is mounted so as to be moved relatively toward and away from the punch holder 28 in a state of being urged downward, that is, toward the mount 26 by a striper bolt (not shown) having an urging member such as a coil spring wound thereon.

The stripper plate 27 is formed with guide holes 30 through which the punches 29 are inserted. The plurality of punches 29 are mounted to the punch holder 28 in a state in which body portions 29b are inserted into the guide holes 30 of the stripper plate 27 and punch distal portions 29a directed downward. The punch holder 28 is configured to be able to move upward and downward with respect to the mount 26.

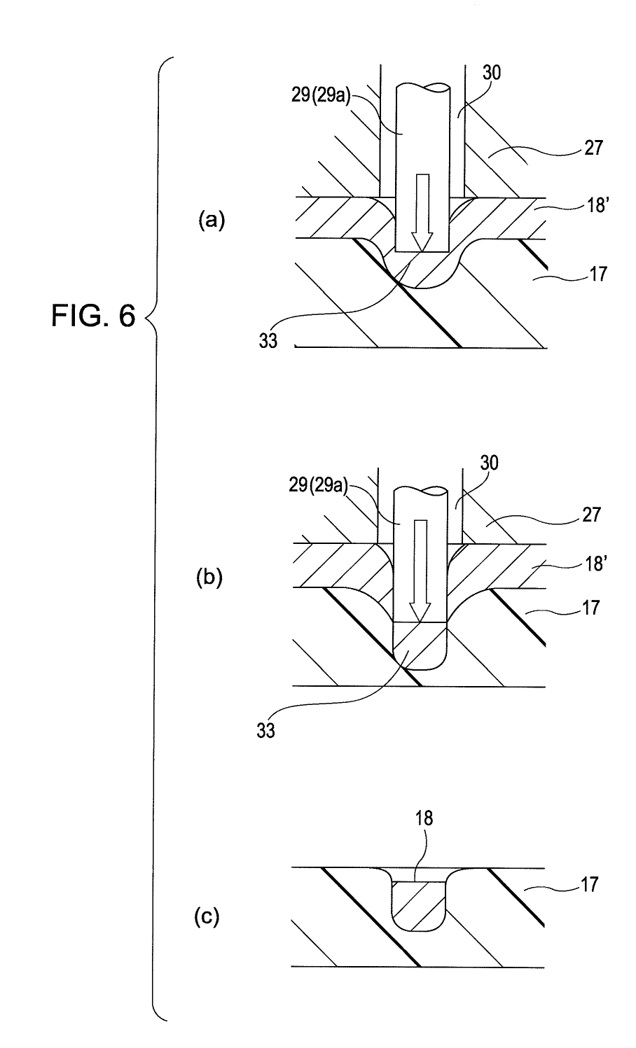

In order to form the detection pattern 19 on the scale base material 17, first of all, the scale base material 17 is arranged on the upper front surface of the mount 26. The pattern base material 18′ as a material of the pattern portions 18 is placed on the upper front surface of the scale base material 17. The pattern base material 18′ is a thin metal sheet material as described above. Then, the punch holder 28 is moved downward toward the mount 26 in this state. Then, the lower front surface of the stripper plate 27 comes into abutment with the front surface (upper front surface) of the pattern base material 18′. Subsequently, when the punch holder 28 is pressed further downward against the urging force of the coil spring, the punches 29 (punch distal portions 29a) are pushed inward from the front surface side toward the back front surface side of the pattern base material 18′ as shown in FIG. 6(a) while being guided by the guide holes 30 of the stripper plate 27. In this case, the punches 29 advance inward while displacing part of the material of the pattern base material 18′ and parts of the pattern base material 18′ which receives the pressing force from the punches 29 are pushed toward the back surface side of the pattern base material 18′ against an elastic force of the scale base material 17 to form protruding portions 33.

Subsequently, as shown in FIG. 6(b), the punches 29 are pushed further inward (downward) in the direction of thickness of the scale base material 17 against the elastic force of the scale base material 17. The distance from the front surface of the pattern base material to the bottom dead centers of the punches at this time, that is, the pushing amount of the punches 29 into the scale base material is preferably double or more the thickness of the pattern base material 18′. Accordingly, the protruding portions 33 come off the main body of the pattern base material 18′ completely and are punched off, and are embedded in the thickness of the scale base material 17.

Subsequently, the punch holder 28 is moved upward. Then, the punch 29 is pulled out from the pattern base material 18′ in a state in which the stripper plate 27 being urged downward is in press contact with the pattern base material 18′. Subsequently, the stripper plate 27 comes apart from the front surface of the pattern base material 18′ upward as the punch holder 28 moves to the top dead center. Then, as shown in FIG. 6(c), portions which used to be the protruding portions 33 are embedded in the thickness of the scale base material as the pattern portions 18 and held therein. Accordingly, the pattern portions 18 are formed on the scale base material 17 without using adhesion or deposition. Since a female die (die) is not necessary, the pressing machine is simplified.

In the manner as described above, the pattern portions 18 are formed on the scale base material 17 at a prescribed distance H (180 LPI in this embodiment) while feeding the pattern base material 18′ and the scale base material 17 in sequence in a laminated state. Accordingly, as shown in FIG. 3, a plurality of the pattern portions 18 are arranged on the scale base material 17 in row in a prescribed distance H, and the stripe detection pattern 19 is formed.

In this manner, since the pattern portions 18 are formed by punching the pattern base material 18′ toward the scale base material 17 via a press work in a state in which the pattern base material 18′ is laminated on the surface of the scale base material 17, embedding the punched pattern base material 18′ in the thickness of the scale base material 17 to be held therein, the abrasion resistance of the pattern portions 18 which constitute the detection pattern 19 may be improved. In other words, for example, abrasion or separation of the pattern portions 18 when the detection pattern 19 comes into contact with the components of the printer 1 such as the cable for transmitting control signals or the charging roller 8 may be restrained. Accordingly, lowering of the detection accuracy of the linear encoder is prevented.

The entire pattern portions 18 is preferably embedded in the thickness of the scale base material 17. Accordingly, the abrasion resistance is further improved. However, the pattern portions 18 do not have to be embedded in the thickness of the scale base material 17 entirely, and the abrasion resistance may be improved in comparison with the related art as long as at least parts of the pattern portions 18 are embedded in the thickness of the scale base material 17.

Although the reflecting type optical scale in which the optical reflection coefficients are different between the scale base material 17 and the pattern portions 18 is exemplified in the above-described embodiment, the invention is not limited thereto. For example, a scale using depressions and projections formed by causing the pattern portions 18 to be depressed or projected with respect to the front surface (upper surface) of the scale base material 17, a magnetic scale formed by magnetizing the pattern portions 18, or a transmission optical scale in which the scale base material 17 having a translucent property and the pattern portions 18 having a light-shielding property are used may be employed. Also, as the detection head 7, any one of contact type, magnetic type, and optical type may be selected depending on the configuration of the linear scale 13 so as to match the conditions of application.

That is, by selecting the sensor which is able to detect the pattern portions 18 as needed and combining the both, the mode of usage which is suitable for the object of usage is achieved. Description will be given with the pattern portions 18 according to another embodiment.

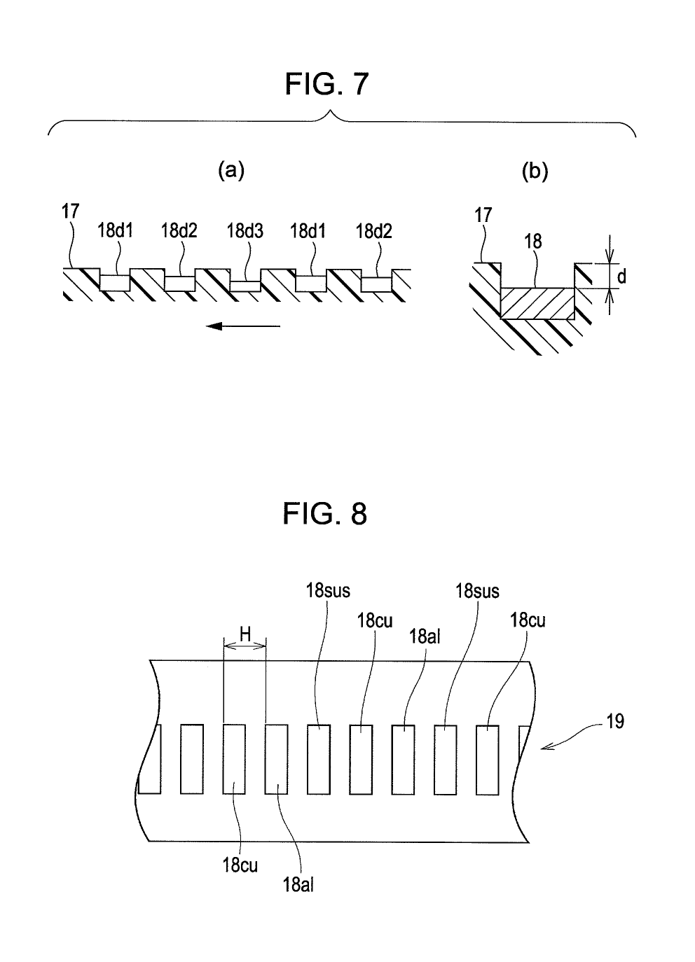

First of all, when embedding the pattern portions 18 entirely in the thickness of the scale base material 17, the detection pattern 19 may be formed in such a manner that the depth from the front surface of the scale base material 17 to the front surfaces of the pattern portions 18 of the detection pattern 19 is differentiated to a plurality of depths and the plurality of depths are set one by one in a predetermined order, and the pattern portions 18 are differentiated in depth repeatedly in this order. For example, as shown in FIG. 7, the detection pattern 19 may be configured by arranging three pattern portions 18d1, 18d2, 18d3 having different depths d from the front surface of the scale base material 17 to the front surface of the pattern portions 18 such as 0.1 mm, 0.2 mm, 0.3 mm in an ascending order at a predetermined distance H and repeating this order. The types of the different depths are not limited to three types described above, and the numerical values of the depth may be set as needed.

When the detection pattern 19 is configured by arranging the pattern portions 18 having different depth in the predetermined order as described above, the pattern portions 18 are detected by the optical sensor, and the depths d of the respective pattern portions 18 may be detected, so that the direction of relative movement with respect to the sensor is detected on the basis of the order of the depths d of the detected pattern portions 18. In other words, when the pattern portions 18 of the moving detection pattern 19 is detected by the fixed sensor and if the detection signal detects the pattern portions 18 in the order from the shallow one to the deep one, the movement is determined to be directed leftward as indicated by an arrow in FIG. 7(a), and if it detects those in the order from the deep one to the shallow one, the movement is detected to be directed in the opposite direction.

In order to enable the detection of the direction of relative movement with respect to the sensor, it is not limited to embed the pattern portions 18 having three different depths as described above, but the pattern portions 18 having three different types of information may be used, and it may be four types, 10 types, and so on. For example, another embodiment of the detection pattern 19 shown in FIG. 8 is configured by selecting one each of a plurality of types of the pattern portions 18 formed of metals of different compositions (materials) in a predetermined order, and arranging the same in this order repeatedly. Specifically, the pattern portions 18 formed of three different metals are arranged in the predetermined order described above repeatedly such as a stainless pattern portion 18sus, then a copper pattern portion 18cu next on the right side, an aluminum pattern portion 18al next on the right side, and so forth. In this configuration as well, the direction of movement may be determined as in the embodiment described above. The compositions of the metals are not limited to those described above, the number of types is not limited to three types, and they may be set as needed.

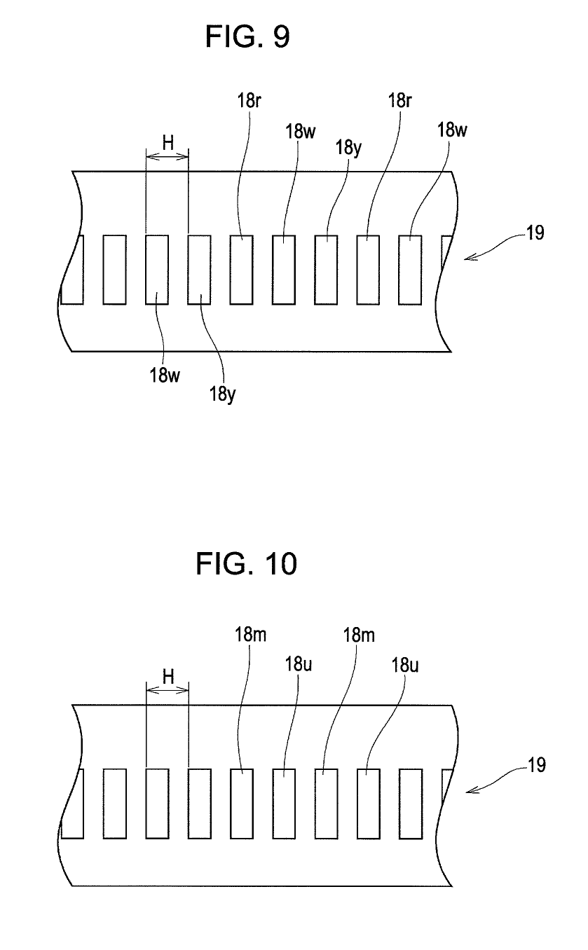

The detection pattern 19 may be configured in such a manner that a plurality of types of the pattern portions 18 having different colors are selected one by one in a predetermined order and arranged in this order. Specifically, as shown in FIG. 9, the pattern portions 18 formed of plastic in three different colors are arranged in a predetermined order described above repeatedly such as a red plastic pattern portion 18r, a white plastic pattern portion 18w next on the right side, a yellow plastic pattern portion 18y next on the right side, and so force. In this configuration as well, the direction of movement may be determined as in the embodiment described above. The colors are not limited to those described above, the number of colors is not limited to three types, and they may be set as needed.

Furthermore, as shown in FIG. 10, the detection pattern 19 may be configured by arranging a pattern portion 18m formed of a magnetic member such as iron or nickel, and a pattern portion 18u formed of a non-magnetic member such as aluminum alternately at a predetermined distance H. The detection pattern 19 in this configuration may be used differently depending on the velocities, such as detecting the pattern portion 18m formed of the magnetic member by a magnetic sensor when moving at a high-velocity, and detecting both the pattern portions 18m, 18u by an optical sensor when moving at a low-velocity.

Also, the shape of the pattern portions 18 is not limited to a slit-shape exemplified in FIG. 3. For example, various shapes of the pattern portions 18 such as a circular shape or a square shape may be employed.

Although the linear encoder for detecting the amount of transport of the printing paper by the transporting belt 3 is exemplified above, the linear encoder (linear scale) according to the present invention may also be used in other applications as a matter of course. For example, in the case of the printer having a configuration in which the printheads are moved reciprocally for printing, it may be used as a linear encoder for detecting the position or velocity of the movement of the printhead in the primary scanning direction.

The shape of the scale is not limited to an elongated shape, and may be other shapes such as a disk shape.

Furthermore, the encoder-equipped apparatus having the encoder does not necessarily have to be a printer, but may be any apparatus having a moving unit which performs movement and having a need to measure the position or the velocity of the moving unit.

The entire disclosure of Japanese Patent Application No. 2008-034031, filed Feb. 15, 2008 is incorporated by reference herein.

The entire disclosure of Japanese Patent Application No. 2009-029226, filed Feb. 12, 2009 is incorporated by reference herein.

1. A method for manufacturing a scale characterized in that a pattern portion is formed by punching a pattern base material toward a scale base material via a press work in a state in which the pattern base material is laminated on the surface of the scale base material, and embedding at least part of the punched pattern base material in a thickness of the scale base material to be held therein.

2. The method for manufacturing a scale according to claim 1, characterized in that a detection pattern is formed by arranging a plurality of the pattern portions at a regular pitch in a row.

3. The method for manufacturing a scale according to claim 1, characterized in that the pattern portions are embedded entirely in the thickness of the scale base material.

4. The method for manufacturing a scale according claim 1, characterized in that the punching is achieved by performing at least two different types of punching in a predetermined sequence according to the position of the scale base material.

5. A scale comprising a scale base material and a pattern portion embedded in a thickness of the scale base material, characterized in that a detection pattern is formed by arranging a plurality of the pattern portions at a regular pitch in a row.

6. The scale according to claim 5, characterized in that the pattern portions are embedded entirely in the thickness of the scale base material.

7. The scale according to claim 5, characterized in that the detection pattern includes pattern portions formed of a plurality of different types of metals having different compositions repeated in a predetermined order.

8. The scale according to claim 5, characterized in that the detection pattern includes a plurality of types of pattern portions having different colors repeated in a predetermined order.

9. The scale according to claim 6, wherein the detection pattern is formed to have a plurality of different depths from the front surface of the scale base material to the front surfaces of the pattern portions, and the plurality of depths are repeated in a predetermined order.

10. An encoder-equipped apparatus comprising a moving unit configured to perform a movement, a scale according to claim 5, and a sensor configured to detect a detection pattern on the scale.
